(19) United States
(12) Patent Application Publication
(10) Pub. No.: US 2022/0210596 A1
(43) Pub. Date: Jun. 30, 2022

(54) METHOD AND APPARATUS FOR PROCESSING AUDIO SIGNAL BASED ON EXTENT SOUND SOURCE

(71) Applicant: ELECTRONICS AND TELECOMMUNICATIONS RESEARCH INSTITUTE, Daejeon (KR)

(72) Inventors: Jae-hyoun YOO, Daejeon (KR); Yong Ju LEE, Daejeon (KR); Dae Young JANG, Daejeon (KR); Kyeongok KANG, Daejeon (KR)

(21) Appl. No.: 17/526,284

(22) Filed: Nov. 15, 2021

(30) Foreign Application Priority Data
Dec. 29, 2020 (KR) 10-2020-0186524

(51) Int. Cl. H04S 7/00

(52) U.S. Cl. CPC H04S 7/303; H04S 2400/11

(57) ABSTRACT

Disclosed is a method and apparatus for processing an audio signal based on an extent sound source. The method includes identifying information on a reference area of the extent sound source and information on a position of a listener, determining a position of a virtual sound source within the extent sound source based on a relationship between the position of the listener and the reference area of the extent sound source, and rendering an audio signal based on the determined position of the virtual sound source, wherein the reference area may be determined based on a position and a size of the extent sound source.

### CROSS-REFERENCE TO RELATED APPLICATION

This application claims the benefit of Korean Patent Application No. 10-2020-0186524 filed on Dec. 29, 2020, in the Korean Intellectual Property Office, the entire disclosure of which is incorporated herein by reference for all purposes.

### BACKGROUND

### 1. Field of the Invention

One or more example embodiments relate to a method and apparatus for processing an audio signal based on an extent sound source, and more particularly, to a technique for rendering an audio signal by setting a reference area of an extent sound source and performing sound localization on a virtual sound source according to a positional relationship between the reference area and a listener.

### 2. Description of Related Art

With the recent increase in the demand for virtual reality (VR) technology or games, research on audio technology for implementing realistic spatial sound is being actively conducted. An object-based audio signal for implementing spatial sound refers to an audio signal rendered in consideration of a relationship between a position of an object and a listener while regarding a sound source as the object.

An existing object-based audio signal processes a sound source as a point in space. However, in the real environment, sound sources may exist in various forms in space. For example, in a natural phenomenon, a fountain, a waterfall, a river, breaking waves, and the like may produce sounds in the whole of a predetermined area.

A sound source that produces a sound in the whole of a predetermined area such as a line or a plane is referred to as an extent sound source. Accordingly, in order to implement realistic spatial sound, a technique for processing an audio signal in consideration of an extent sound source is needed.

### SUMMARY

Example embodiments provide a method and apparatus for processing an extent sound source with a small amount of computation by setting a reference area of the extent sound source and performing sound localization on a virtual sound source according to a positional relationship between the reference area and a listener.

Example embodiments provide a method and apparatus for providing realistic spatial sound by rendering an audio signal for an extent sound source, without performing individual sound localization on a virtual sound source in all areas of the extent sound source.

According to an aspect, there is provided a method of processing an audio signal based on an extent sound source, the method including identifying information on a reference area of the extent sound source and information on a position of a listener, determining a position of a virtual sound source within the extent sound source based on a relationship between the position of the listener and the reference area of the extent sound source, and rendering an audio signal based on the determined position of the virtual sound source, wherein the reference area may be determined based on a position and a size of the extent sound source.

The determining of the position of the virtual sound source may include determining the position of the virtual sound source corresponding to the position of the listener, when the position of the listener is included in the reference area of the extent sound source.

The determining of the position of the virtual sound source may include determining the position of the virtual sound source in an edge area of the extent sound source, when the position of the listener is not included in the reference area of the extent sound source.

The rendering may include rendering the audio signal based on a frequency response of the listener to a virtual sound source positioned in front of the listener, when the position of the listener is included in the reference area of the extent sound source.

The rendering may include rendering the audio signal based on a frequency response of the listener to a virtual sound source positioned in an edge area of the extent sound source, when the position of the listener is not included in the reference area of the extent sound source.

According to an aspect, there is provided a method of processing an audio signal based on an extent sound source, the method including identifying information on a reference area of the extent sound source and information on a position of a listener, determining whether the position of the listener is included in the reference area of the extent sound source, determining a sound localization point of a virtual sound source corresponding to the position of the listener, when the position of the listener is included in the reference area of the extent sound source, determining the sound localization point of the virtual sound source in an edge area of the extent sound source, when the position of the listener is not included in the reference area of the extent sound source, and rendering the audio signal based on the sound localization point.

The rendering may include rendering the audio signal based on a frequency response of the listener to a sound localization point positioned in front of the listener, when the position of the listener is included in the reference area of the extent sound source.

The rendering may include rendering the audio signal based on a frequency response of the listener to a sound localization point positioned in an edge area of the extent sound source, when the position of the listener is not included in the reference area of the extent sound source.

According to an aspect, there is provided a processing apparatus to perform a method of processing an audio signal based on an extent sound source, the processing apparatus including a processor, wherein the processor may be configured to identify information on a reference area of the extent sound source and information on a position of a listener, determine a position of a virtual sound source within the extent sound source based on a relationship between the position of the listener and the reference area of the extent sound source, and render an audio signal based on the determined position of the virtual sound source, wherein the reference area may be determined based on a position and a size of the extent sound source.

The processor may be further configured to determine the position of the virtual sound source corresponding to the position of the listener, when the position of the listener is included in the reference area of the extent sound source.

The processor may be further configured to determine the position of the virtual sound source in an edge area of the extent sound source, when the position of the listener is not included in the reference area of the extent sound source.

The processor may be further configured to render the audio signal based on a frequency response of the listener to a virtual sound source positioned in front of the listener, when the position of the listener is included in the reference area of the extent sound source.

The processor may be further configured to render the audio signal based on a frequency response of the listener to a virtual sound source positioned in an edge area of the extent sound source, when the position of the listener is not included in the reference area of the extent sound source.

According to an aspect, there is provided a processing apparatus to perform a method of processing an audio signal based on an extent sound source, the processing apparatus including a processor, wherein the processor may be configured to identify information on spatial coordinates of the extent sound source and spatial coordinates of a position of a listener, determine whether the position of the listener is included in a reference area of the extent sound source, determine a sound localization point of a virtual sound source corresponding to the position of the listener, when the position of the listener is included in the reference area of the extent sound source, determine the sound localization point of the virtual sound source in an edge area of the extent sound source, when the position of the listener is not included in the reference area of the extent sound source, and render the audio signal based on the sound localization point.

The processor may be further configured to render the audio signal based on a frequency response of the listener to a sound localization point positioned in front of the listener, when the position of the listener is included in the reference area of the extent sound source.

The processor may be further configured to render the audio signal based on a frequency response of the listener to a sound localization point positioned in an edge area of the extent sound source, when the position of the listener is not included in the reference area of the extent sound source.

Additional aspects of example embodiments will be set forth in part in the description which follows and, in part, will be apparent from the description, or may be learned by practice of the disclosure.

According to example embodiments, it is possible to process an extent sound source with a small amount of computation by setting a reference area of the extent sound source and performing sound localization on a virtual sound source according to a positional relationship between the reference area and a listener.

According to example embodiments, it is possible to provide realistic spatial sound by rendering an audio signal for an extent sound source, without performing individual sound localization on a virtual sound source in all areas of the extent sound source.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an apparatus for processing an audio signal according to an example embodiment;

FIG. 2 illustrates an example of representing an extent sound source on a spatial coordinate system according to an example embodiment;

FIG. 3 illustrates a reference area of an extent sound source according to an example embodiment;

FIGS. 4A to 4D illustrate an example of representing a positional relationship between an extent sound source and listeners on a spatial coordinate system according to an example embodiment;

FIG. 5 illustrates an example of applying a head-related transfer function (HRTF) according to a position of a listener relative to an extent sound source according to an example embodiment; and

FIG. 6 is a flowchart illustrating a method of processing an audio signal according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

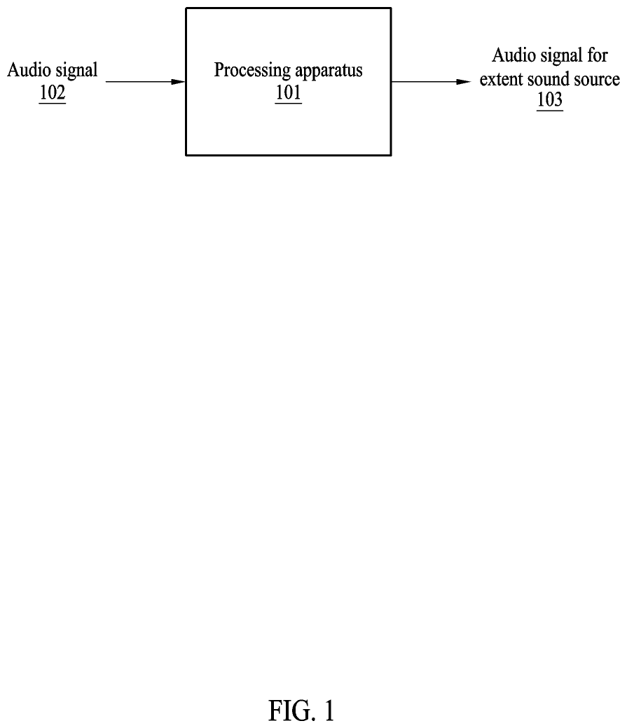

FIG. 1 illustrates an apparatus for processing an audio signal according to an example embodiment.

The present disclosure relates to a technique for processing an audio signal 102 by setting a reference area of an extent sound source and performing sound localization on a virtual sound source according to a positional relationship between the reference area and a listener, for rendering the audio signal 102 for the extent sound source with a small amount of computation.

A method of processing the audio signal 102 based on an extent sound source may be performed by a processing apparatus 101. The processing apparatus 101 may include a processor of an electronic device such as a smartphone, a PC, or a tablet.

Referring to FIG. 1, the processing apparatus 101 may generate an audio signal 103 for an extent sound source from the audio signal 102. The audio signal 103 for the extent sound source may be an audio signal 103 rendered as an object-based audio signal 103 in consideration of the extent sound source.

The processing apparatus 101 may determine whether a position of a listener is included in a reference area of the extent sound source, determine a position of a virtual sound source according to a determination result, and render the audio signal 102 based on the determined position of the virtual sound source.

Herein, the extent sound source may be a line or a plane, and the type of the line or the plane is not limited to examples set forth herein. That is, when the extent sound source is a line, the extent sound source may be in various shapes such as a straight line, a curve, and the like. When the extent sound source is a plane, the extent sound source may be in various shapes such as a triangle, a rectangle, a pentagon, and the like.

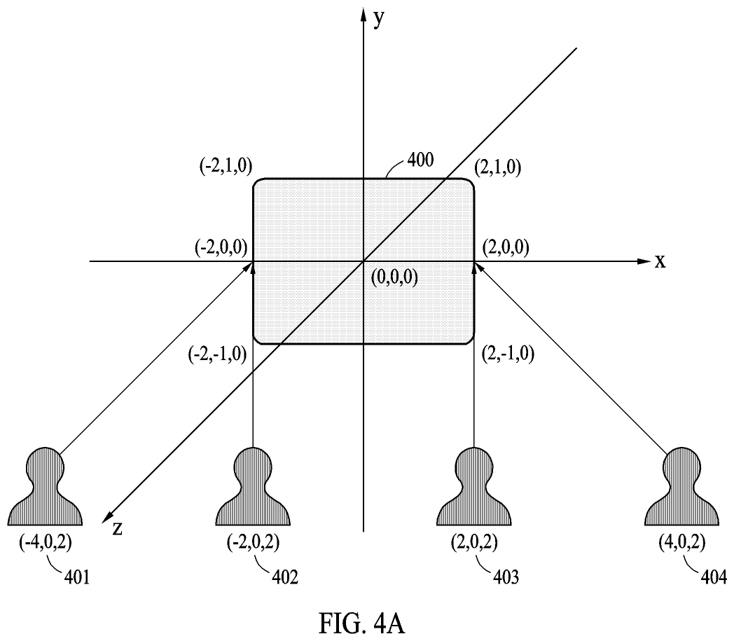

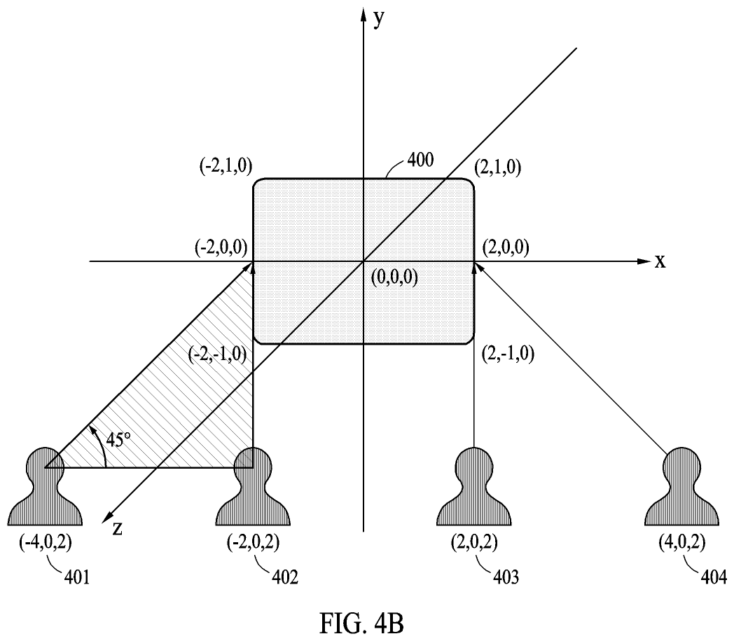

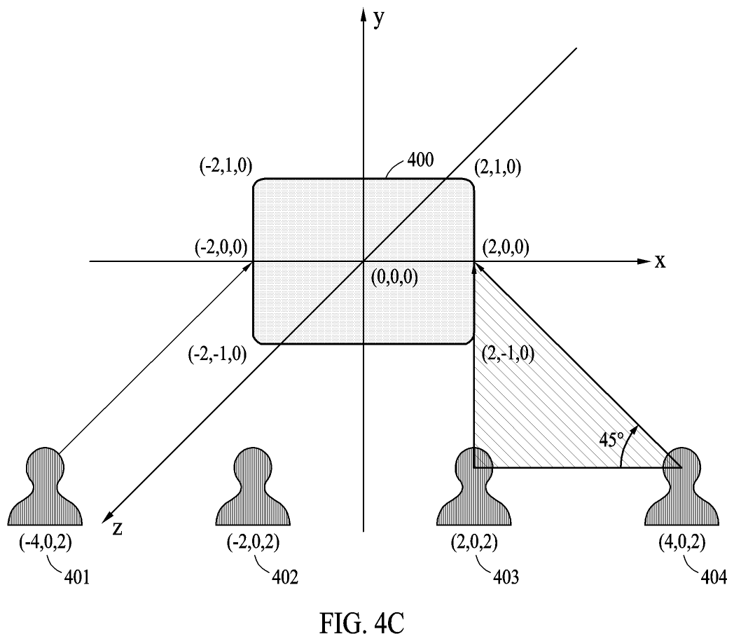

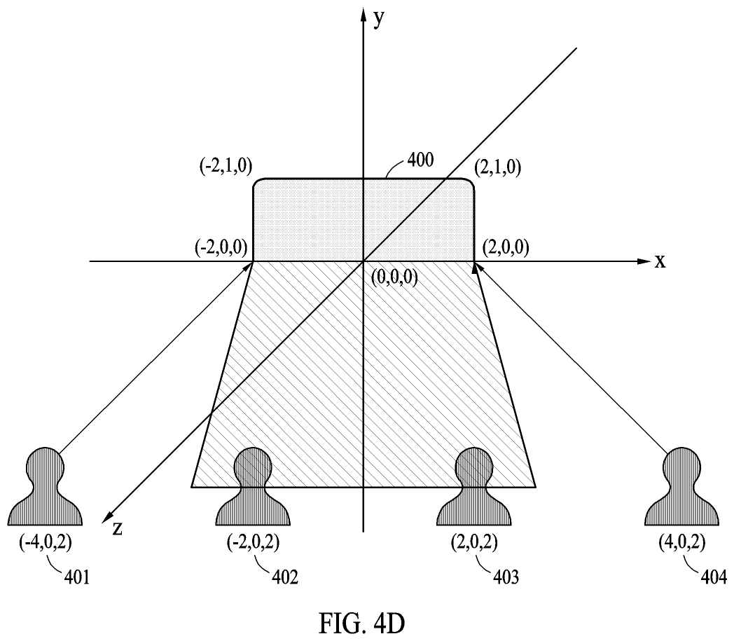

The reference area may be determined to determine the position of the virtual sound source within the extent sound source. The reference area may be an area determined according to a position and a size of the extent sound source, and an area in three-dimensional space. The reference area may be determined based on spatial coordinates of the extent sound source. The reference area will be described further with reference to FIGS. 4A to 4D.

Specifically, the processing apparatus 101 may identify spatial coordinates of the position of the extent sound source and spatial coordinates of the position of the listener. The processing apparatus 101 may determine whether the position of the listener is included in the reference area of the extent sound source based on the spatial coordinates of the position of the extent sound source and the spatial coordinates of the position of the listener.

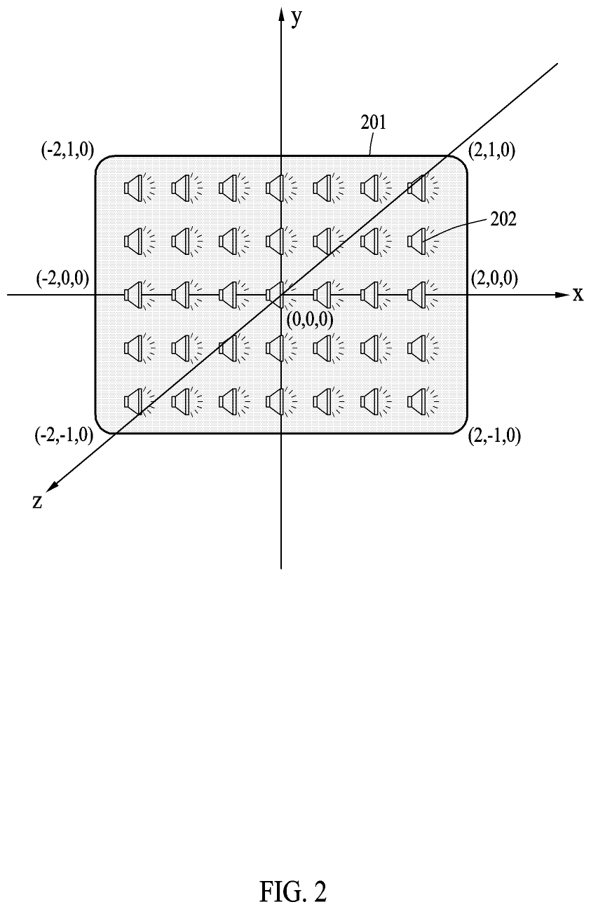

FIG. 2 illustrates an example of representing an extent sound source on a spatial coordinate system according to an example embodiment.

An extent sound source 201 of FIG. 2 may be a rectangular plane included on an x-y plane in three-dimensional space. Spatial coordinates of the extent sound source 201 of FIG. 2 may be all points included in an area of the extent sound source 201, for example, (−2, 1, 0), (2, 1, 0), (−2, −1, 0), (2, −1, 0), (0, 0, 0), and the like.

To generate an audio signal for the extent sound source 201, all points included in the area of the extent sound source 201 may be determined as virtual sound sources 202, as shown in FIG. 2. However, in this case, an excessive number of virtual sound sources 202 are included, resulting in an excessive increase in the size of content data including the audio signal or the amount of computation.

Therefore, in terms of computational efficiency or data size, it may be advantageous to determine virtual sound sources 202 using the position of the listener and the position and size of the extent sound source 201 based on the spatial coordinates of the extent sound source 201.

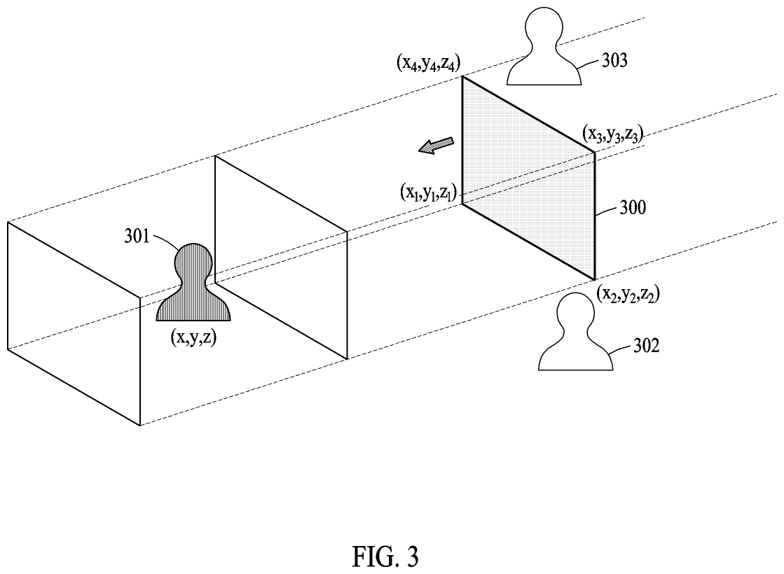

FIG. 3 illustrates a reference area of an extent sound source according to an example embodiment.

An extent sound source 300 of FIG. 3 may be a plane in three-dimensional space. When a position 301, 302, 303 of a listener is included in a normal of a plane corresponding to the extent sound source 300 in space, a processing apparatus may determine that the position of the listener is included in a reference area of the extent sound source 300.

For example, referring to FIG. 3, the position 301 of the listener is included in the normal of the plane corresponding to the extent sound source 300. Thus, the processing apparatus may determine that the position 301 of the listener is included in the reference area of the extent sound source 300.

When the position 301 of the listener is included in the reference area of the extent sound source 300, the processing apparatus may determine a position of a virtual sound source within the extent sound source 300 corresponding to the position 301 of the listener. That is, the processing apparatus may determine a sound localization point of the virtual sound source within the extent sound source 300 corresponding to the position 301 of the listener.

Specifically, when the position 301 of the listener is included in the reference area of the extent sound source 300, the processing apparatus may determine a position closest to the position 301 of the listener within the extent sound source 300 as the position of the virtual sound source. That is, when the position 301 of the listener is included in the reference area of the extent sound source 300, the processing apparatus may determine the point closest to the position 301 of the listener on the plane corresponding to the extent sound source 300 as the sound localization point of the virtual sound source.

For example, referring to FIG. 3, the positions 302 and 303 of the listeners are not included in the normal of the plane corresponding to the extent sound source 300. Thus, the processing apparatus may determine that the positions 302 and 303 of the listeners are not included in the reference area of the extent sound sources 300.

When the positions 302 and 303 of the listeners are not included in the reference area of the extent sound source 300, the processing apparatus may determine the position of the virtual sound source in an edge area of the extent sound source 300. That is, the processing apparatus may determine the sound localization point of the virtual sound source in the edge area of the extent sound source 300. The edge area will be described further with reference to FIGS. 4A to 4D.

FIGS. 4A to 4D illustrate an example of representing a positional relationship between an extent sound source and listeners on a spatial coordinate system according to an example embodiment.

An extent sound source 400 of FIGS. 4A to 4D may be a rectangular plane included on an x-y plane in three-dimensional space, as in FIG. 2. Herein, positions 401 to 404 of listeners may be specified as points. The positions 401 to 404 of the listeners may be any position on spatial coordinates. In FIGS. 4A to 4D, the positions 401 to 404 of the listeners may be (−4, 0, 2), (−2, 0, 2), (2, 0, 2), and (4, 0, 2).

FIG. 4B illustrates an example in which the position 401 of the listener relative to the extent sound source 400 of FIG. 2 is (−4, 0, 2).

In FIG. 4B, when the position 401 of the listener is (−4, 0, 2), the position 401 of the listener may not be included in the reference area of the extent sound source 400. When the position 401 of the listener is not included in the reference area of the extent sound source 400, the processing apparatus may determine a position of a virtual sound source in an edge area of the extent sound source 400.

Specifically, referring to FIG. 4B, the processing apparatus may determine a point (e.g., coordinates (−2, 0, 0)) closest to the position 401 of the listener within an edge area (e.g., an edge (a line segment connecting coordinates (−2, 1, 0) and coordinates (−2, −1, 0))) of the extent sound source 400 as the position of the virtual sound source. That is, the processing apparatus may determine the point closest to the position 401 of the listener on a plane corresponding to the extent sound source 400 as the sound localization point of the virtual sound source.

The processing apparatus may render an audio signal based on a frequency response of the listener to the virtual sound source positioned in the edge area. For example, in FIG. 4B, when the position 401 of the listener is (−4, 0, 2), the processing apparatus may process the sound localization by applying a right head-related transfer function (HRTF). Specifically, in the example of FIG. 4B, the processing apparatus may render the audio signal by applying a 45-degree right HRTF.

FIG. 4C illustrates an example in which the position 404 of the listener relative to the extent sound source 400 of FIG. 2 is (4, 0, 2).

In FIG. 4C, when the position 404 of the listener is (4, 0, 2), the position 404 of the listener may not be included in the reference area of the extent sound source 400. When the position 404 of the listener is not included in the reference area of the extent sound source 400, the processing apparatus may determine a position of a virtual sound source in an edge area of the extent sound source 400.

Specifically, referring to FIG. 4C, the processing apparatus may determine a point (e.g., coordinates (2, 0, 0)) closest to the position 404 of the listener within an edge area (e.g., an edge (a line segment connecting coordinates (2, 1, 0) and coordinates (2, −1, 0))) of the extent sound source 400 as the position of the virtual sound source. That is, the processing apparatus may determine the point closest to the position 404 of the listener on the plane corresponding to the extent sound source 400 as the sound localization point of the virtual sound source.

The processing apparatus may render an audio signal based on a frequency response of the listener to the virtual sound source positioned in the edge area. For example, in FIG. 4C, when the position 404 of the listener is (4, 0, 2), the processing apparatus may process the sound localization by applying a left HRTF. Specifically, in the example of FIG. 4C, the processing apparatus may render the audio signal by applying a 45-degree left HRTF.

FIG. 4D illustrates an example in which the positions 402 and 403 of the listeners relative to the extent sound source 400 of FIG. 2 are (−2, 0, 2) and (2, 0, 2).

In FIG. 4D, when the positions 402 and 403 of the listeners are (−2, 0, 2) and (2, 0, 2), the positions 402 and 403 of the listeners may be included in the reference area of the extent sound source 400. When the positions 402 and 403 of the listeners are included in the reference area of the extent sound source 400, the processing apparatus may determine positions of virtual sound sources within the extent sound source 400 corresponding to the positions 402 and 403 of the listeners.

The processing apparatus may determine positions of virtual sound sources within the extent sound source 400 corresponding to the positions 402 and 403 of the listeners. That is, the processing apparatus may determine sound localization points of the virtual sound sources within the extent sound source 400 corresponding to the positions 402 and 403 of the listeners.

Specifically, when the positions 402 and 403 of the listeners are included in the reference area of the extent sound source 300, the processing apparatus may determine positions (e.g., (−2, 0, 0) when the position of the listener is (−2, 0, 2), and (2, 0, 0) when the position of the listener is (2, 0, 2)) closest to the positions 402 and 403 of the listeners within the extent sound source 400 as the positions of the virtual sound sources.

That is, when the positions 402 and 403 of the listeners are included in the reference area of the extent sound source 400, the processing apparatus may determine the points closest to the positions 402 and 403 of the listeners on the plane corresponding to the extent sound source 400 as the sound localization points of the virtual sound sources.

The processing apparatus may render the audio signal based on frequency responses of the listeners to the virtual sound sources positioned in front of the listeners. For example, in FIG. 4D, when the positions 402 and 403 of the listeners are (−2, 0, 2) and (2, 0, 2), the processing apparatus may process the sound localization by applying a HRTF. Specifically, in the example of FIG. 4D, the processing apparatus may render the audio signal by applying a 0-degree HRTF.

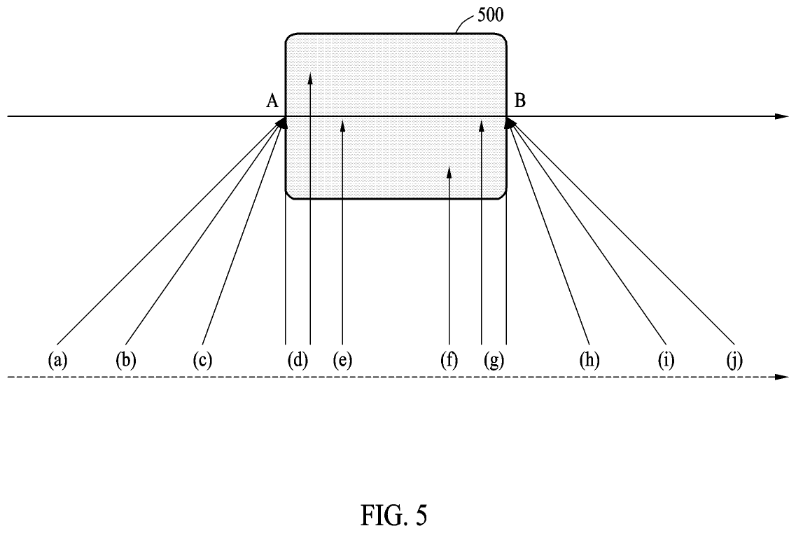

FIG. 5 illustrates an example of applying a head-related transfer function (HRTF) according to a position of a listener relative to an extent sound source according to an example embodiment.

Referring to FIG. 5, positions of virtual sound sources and HRTF application directions may be determined according to positions (a) to (j) of listeners. For example, when a position of a listener is (a), (b) or (c) of FIG. 5, the position of the listener is not included in a reference area of an extent sound source 500, and thus, a position of a virtual sound source may be determined to a point A closest to the position (a), (b) or (c) of the listener of FIG. 5 within the extent sound source 500.

When the position of the listener is (a) of FIG. 5, a −45-degree HRTF may be applied according to the angle between the listener and the point A (45 degrees to the right of the listener). When the position of the listener is (b) of FIG. 5, a −35-degree HRTF may be applied according to the angle between the listener and the point A (35 degrees to the right of the listener). When the position of the listener is (c) of FIG. 5, a −20-degree HRTF may be applied according to the angle between the listener and the point A (20 degrees to the right of the listener).

For example, when a position of a listener is (d), (e), (f) or (g) of FIG. 5, a position of a virtual sound source may be determined to a point closest to the position (d), (e), (f) or (g) of the listener of FIG. 5 within the extent sound source 500. When the position of the listener is (d), (e), (f) or (g) of FIG. 5, the position of the listener is included in the reference area, and thus, a 0-degree HRTF may be applied.

For example, when a position of a listener is (h), (i) or (j) of FIG. 5, the position of the listener is not included in the reference area of the extent sound source 500, and thus, a position of a virtual sound source may be determined to a point B closest to the position (h), (i) or (j) of the listener of FIG. 5 within the extent sound source 500.

When the position of the listener is (h) of FIG. 5, a 45-degree HRTF may be applied according to the angle between the listener and the point B (45 degrees to the left of the listener). When the position of the listener is (i) of FIG. 5, a 35-degree HRTF may be applied according to the angle between the listener and the point B (35 degrees to the left of the listener). When the position of the listener is (j) of FIG. 5, a 20-degree HRTF may be applied according to the angle between the listener and the point B (20 degrees to the left of the listener).

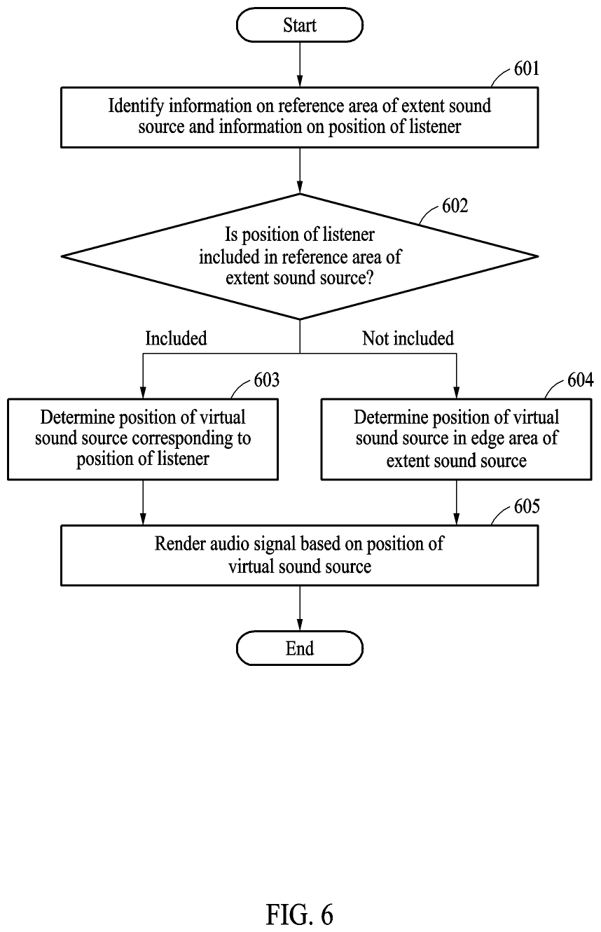

FIG. 6 is a flowchart illustrating a method of processing an audio signal according to an example embodiment.

In operation 601, a processing apparatus may identify information on a reference area of an extent sound source and information on a position of a listener. The information on the reference area of the extent sound source and the information on the position of the listener may be identified by spatial coordinates.

In operation 602, the processing apparatus may determine whether the position of the listener is included in the reference area of the extent sound source. When the position 301, 302, 303 of the listener is included in a normal of a plane corresponding to the extent sound source, the processing apparatus may determine that the position of the listener is included in the reference area of the extent sound source.

In operation 603, the processing apparatus may determine a position of a virtual sound source corresponding to the position of the listener, when the position of the listener is included in the reference area of the extent sound source. That is, when the position of the listener is included in the reference area of the extent sound source, the processing apparatus may determine a sound localization point within the extent sound source corresponding to the position of the listener.

In operation 604, the processing apparatus may determine a sound localization point of the virtual sound source in an edge area of the extent sound source, when the position of the listener is not included in the reference area of the extent sound source.

The processing apparatus may determine a position closest to the position of the listener within the extent sound source as the position of the virtual sound source. That is, the processing apparatus may determine a point closest to the position of the listener on a plane or a line corresponding to the extent sound source as the position of the virtual sound source.

In operation 605, the processing apparatus may render an audio signal based on the position of the virtual sound source. The processing apparatus may render the audio signal based on a frequency response of the listener to the determined position of the virtual sound source.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of processing an audio signal based on an extent sound source, the method comprising:
identifying information on a reference area of the extent sound source and information on a position of a listener;
determining a position of a virtual sound source within the extent sound source based on a relationship between the position of the listener and the reference area of the extent sound source; and
rendering an audio signal based on the determined position of the virtual sound source,
wherein the reference area is determined based on a position and a size of the extent sound source.

2. The method of claim 1, wherein the determining of the position of the virtual sound source comprises determining the position of the virtual sound source corresponding to the position of the listener, when the position of the listener is included in the reference area of the extent sound source.

3. The method of claim 1, wherein the determining of the position of the virtual sound source comprises determining the position of the virtual sound source in an edge area of the extent sound source, when the position of the listener is not included in the reference area of the extent sound source.

4. The method of claim 1, wherein the rendering comprises rendering the audio signal based on a frequency response of the listener to a virtual sound source positioned in front of the listener, when the position of the listener is included in the reference area of the extent sound source.

5. The method of claim 1, wherein the rendering comprises rendering the audio signal based on a frequency response of the listener to a virtual sound source positioned in an edge area of the extent sound source, when the position of the listener is not included in the reference area of the extent sound source.

6. A method of processing an audio signal based on an extent sound source, the method comprising:
identifying information on a reference area of the extent sound source and information on a position of a listener;
determining whether the position of the listener is included in the reference area of the extent sound source;
determining a sound localization point of a virtual sound source corresponding to the position of the listener, when the position of the listener is included in the reference area of the extent sound source;
determining the sound localization point of the virtual sound source in an edge area of the extent sound source, when the position of the listener is not included in the reference area of the extent sound source; and
rendering the audio signal based on the sound localization point.

7. The method of claim 6, wherein the rendering comprises rendering the audio signal based on a frequency response of the listener to a sound localization point positioned in front of the listener, when the position of the listener is included in the reference area of the extent sound source.

8. The method of claim 6, wherein the rendering comprises rendering the audio signal based on a frequency response of the listener to a sound localization point positioned in an edge area of the extent sound source, when the position of the listener is not included in the reference area of the extent sound source.

9. A processing apparatus to perform a method of processing an audio signal based on an extent sound source, the processing apparatus comprising:
a processor,
wherein the processor is configured to identify information on a reference area of the extent sound source and information on a position of a listener, determine a position of a virtual sound source within the extent sound source based on a relationship between the position of the listener and the reference area of the extent sound source, and render an audio signal based on the determined position of the virtual sound source,
wherein the reference area is determined based on a position and a size of the extent sound source.

10. The processing apparatus of claim 9, wherein the processor is further configured to determine the position of the virtual sound source corresponding to the position of the listener, when the position of the listener is included in the reference area of the extent sound source.

11. The processing apparatus of claim 9, wherein the processor is further configured to determine the position of the virtual sound source in an edge area of the extent sound source, when the position of the listener is not included in the reference area of the extent sound source.

12. The processing apparatus of claim 9, wherein the processor is further configured to render the audio signal based on a frequency response of the listener to a virtual sound source positioned in front of the listener, when the position of the listener is included in the reference area of the extent sound source.

13. The processing apparatus of claim 9, wherein the processor is further configured to render the audio signal based on a frequency response of the listener to a virtual sound source positioned in an edge area of the extent sound source, when the position of the listener is not included in the reference area of the extent sound source.
